(19) United States
(12) Patent Application Publication
(10) Pub. No.: US 2007/0221897 A1
(43) Pub. Date: Sep. 27, 2007

(54) Ratcheted winch bar

(76) Inventor: Edgardo Cardona, Walnutport, PA (US)

Correspondence Address: YOUNG & BASILE, P.C., 3001 WEST BIG BEAVER ROAD, SUITE 624, TROY, MI, 48084, US

(21) Appl. No.: 11/385,570

(22) Filed: Mar. 21, 2006

(51) Int. Cl. B25B 25/00

(52) U.S. Cl. 254/218

(57) ABSTRACT

A ratcheted winch bar for winding a cargo strap on a cargo winch. The ratcheted winch bar comprises a handle portion having a ratchet body attached to an end thereof. A mandrel is rotatably connected to the ratchet body, and may be received within the cargo winch. An engagement key is removably attachable to the mandrel for engaging the cargo winch to thereby wind the cargo strap.

### FIELD OF THE INVENTION

The present invention relates to the field of winch bars, and more particularly, the present invention relates to a ratcheted winch bar for engaging a cargo winch to thereby wind a cargo strap.

### BACKGROUND OF THE INVENTION

Straps are commonly used to secure cargo to flatbed trucks and trailers. In order to secure and tighten cargo straps, trucks and trailers are often equipped with cargo winches that include a drum upon which the cargo strap may be spooled, and a ratchet mechanism to hold the cargo strap under tension. Typically, an elongated metal bar, commonly known as a winch bar, is used to tighten cargo straps. In order to tighten a cargo strap using a winch bar, the winch bar is inserted into apertures formed in a drive member that is attached to the drum, and the winch bar is then used as a lever to turn the drum, thereby advancing the ratchet mechanism of the cargo winch. However, traditional winch bars are only operable over a limited range of motion. Therefore, the winch bar must be repeatedly removed from the apertures in the drive member and then reinserted in order to tighten the strap. Consequently, the process of tightening a cargo strap can be tedious and time-consuming. Continuous removal and reinsertion of the winch bar into the drive also creates a heightened risk that the winch bar may be improperly inserted into the drive member, which could lead to injury of the user of the winch bar. Furthermore, in many cargo transportation applications, a number of cargo straps must be tightened to secure cargo on a flatbed trailer, thus multiplying the lost time and risk of injury associated with tightening cargo straps.

Numerous apparatuses have been proposed to facilitate the process of safely and efficiently winding a cargo strap upon the drum of a cargo winch For example, a number of apparatuses are known that comprise a winch bar having a particular structure for preventing slippage or incorrect insertion of the winch bar with respect to the cargo winch. However, these apparatuses require repeated engagement and disengagement of the cargo winch in order to wind the cargo strap. Other apparatuses are known which comprise handles capable of 360 degree rotation, but which provide a significantly shorter lever arm than a traditional winch bar. Thus, such structures are useful for winding a cargo strap that is not under tension, but such structures are not useful for tightening a cargo strap to thereby secure cargo.

It would be desirable to have a ratcheted winch bar wherein the cargo strap of a cargo winch could be tightened without having to repeatedly remove and reinsert the winch bar into the drum of the cargo winch.

### SUMMARY OF THE INVENTION

The present invention relates to a ratcheted winch bar for winding a cargo strap on a cargo winch. The ratcheted winch bar includes a handle portion, and a ratchet body connected to an end of the handle portion. A mandrel is rotatably connected to the ratchet body and may be received within the cargo winch. In order to engage the cargo winch to tighten the cargo strap, an engagement key is removably attachable to the mandrel.

The mandrel extends along an axis which is substantially perpendicular to the handle portion, and a slot extends through the mandrel substantially perpendicular to the axis. The engagement key may be received within the slot, and the engagement key may be retained in the slot by a pin that extends at least partially into the slot so that the pin may engage the engagement key to retain the engagement key within the slot. The engagement key is greater in length than the slot, wherein the ends of the engagement key extend out of the mandrel when the engagement key is disposed within the slot.

A gear and pawl disposed within the ratchet body serve to ratchet the motion of the mandrel. The gear and mandrel are connected for uniform rotation in a first direction and a second direction. The pawl is movable between a first position, wherein the gear and mandrel are restrained against rotating in the first direction, and a second position, wherein the gear and mandrel are restrained against moving in the second direction.

An enclosure may be attached to the ratchet body for transportation and storage of the engagement key. The engagement key is disposable within the enclosure, and a spring flange attached to the enclosure is engageable with the engagement key to retain the engagement key within the enclosure.

### BRIEF DESCRIPTION OF THE DRAWINGS

The description herein makes reference to the accompanying drawings wherein like referenced numerals refer to like parts throughout several views and wherein:

FIG. 1 is an illustration showing the ratcheted winch bar of the present invention engaged with a cargo winch;

FIG. 2 is a front view of a cargo winch;

FIG. 3 is a top view of the ratcheted winch bar of the present invention;

FIG. 4 is a perspective view of the ratchet body of the ratcheted winch bar of the present invention;

FIG. 5A is a cross-section view of the ratchet body of the ratcheted winch bar of the present invention wherein the pawl is in the first position;

FIG. 5B is a cross-section view of the ratchet body of the ratcheted winch bar of the present invention wherein the pawl is in the second position;

FIG. 6 is a cross-section view of the ratchet body and mandrel of the ratcheted winch bar of the present invention;

FIG. 7 is a detail view of the engagement key of the ratcheted winch bar of the present invention; and

FIG. 8 is a detail view of the engagement key holder of the ratcheted winch bar of the present invention.

### DETAILED DESCRIPTION OF THE PREFERRED EMBODIMENTS

Referring to the drawings, the present invention will now be described in detail with reference to the disclosed embodiment.

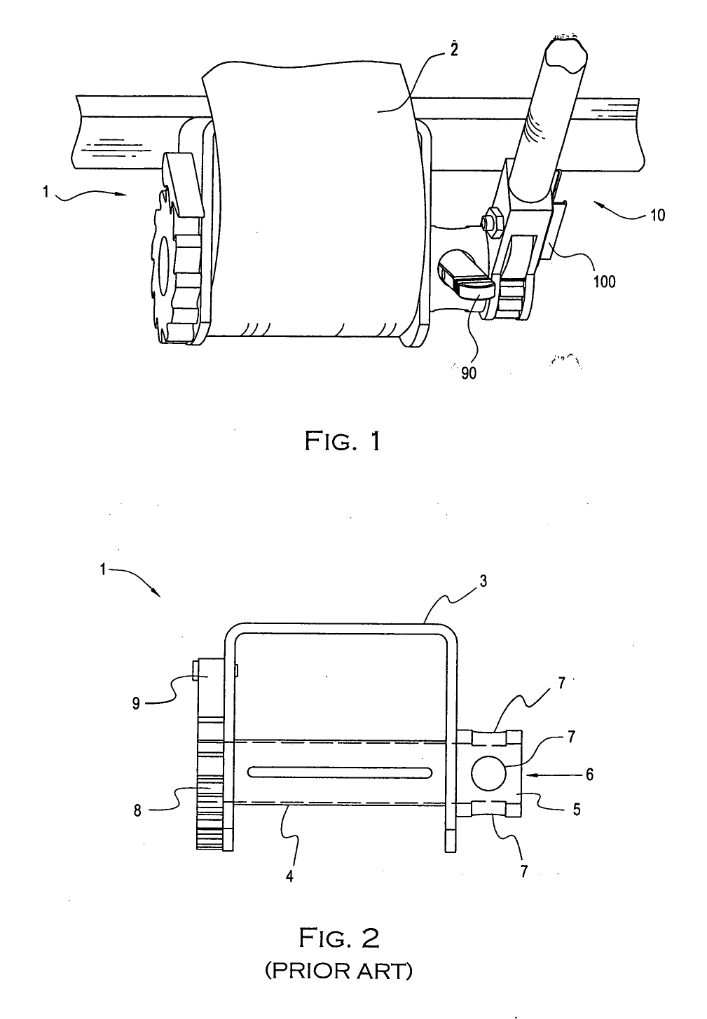

FIG. 1 shows a ratcheted winch bar 10 of the present invention engaged with a cargo winch 1 to thereby tension a cargo strap 2. The cargo winch 1 is of a type commonly used to secure cargo upon a vehicle, such as a flatbed trailer (not shown), to which a frame 3 of the cargo winch 1 may be secured, as shown in FIG. 2. The cargo winch 1 includes a drum 4 connected to a drive member 5, both of which may rotate with respect to the frame 3. The drum 4 serves to carry the cargo strap 2, while the drive member 5 may be manipulated by a tool, such as the ratcheted winch bar 10, to tighten the cargo strap 2. So that a tool may engage the drive member 5 of the cargo winch 1, the drive member 5 is generally tubular, having a passageway 6 defined by the hollow interior of the tubular drive member 5. To further facilitate engagement of a tool with the drive member 5, two of apertures 7 are spaced 180° apart on the annular periphery of the drive member 5. Connected to the end of the drum 4 opposite the drive member 5, a gear 8 and an associated pawl 9 allow the cargo strap 1 to be held under tension.

It should be noted that although the ratcheted winch bar 10 will be described herein with regard to its use with the cargo winch 1, the cargo winch 1 is described herein for the sole purpose of providing context to the description of the ratcheted winch bar 10, and the ratcheted winch bar 10 is not limited to use with the particular cargo winch 1 described herein.

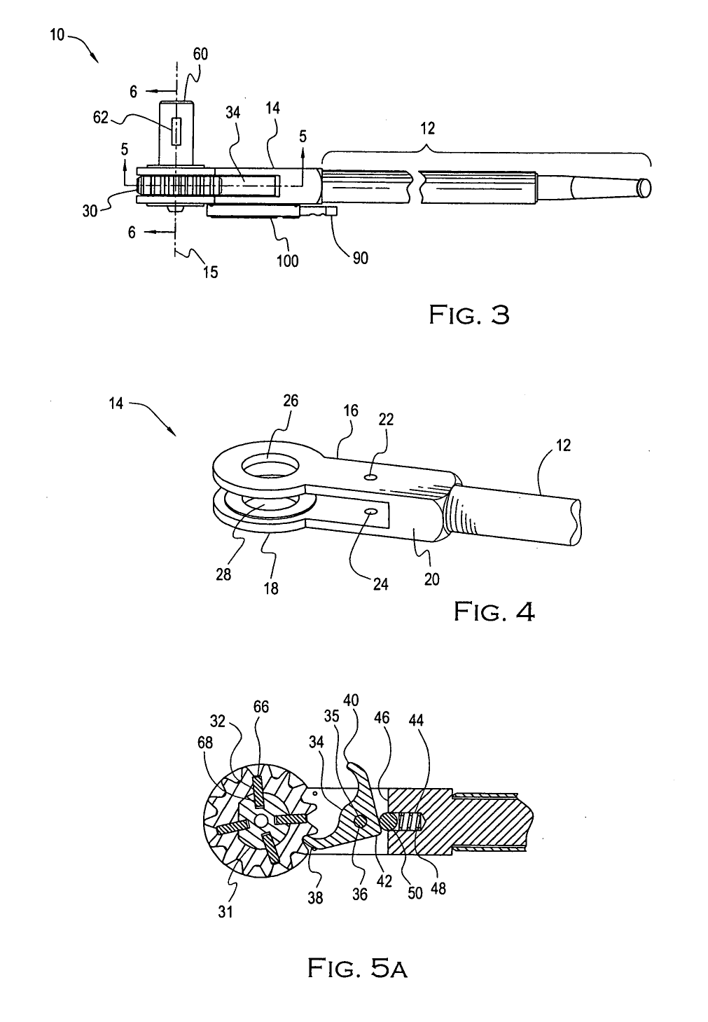

As shown in FIG. 3, the ratcheted winch bar 10 includes an elongated handle portion 12 that is connected to a ratchet body 14 at one end. A mandrel 60 extends through the ratchet body 14 along an axis 15 that is perpendicular to the elongated handle portion 12. The mandrel 60 is connected to a gear 30 and associated pawl 34 for selective rotation in either a first direction or a second direction. The mandrel 60 is receivable within the passageway 6 in the drive member 5 of the cargo winch 1. In order to engage the mandrel 60 and the drive member 5 so that the ratcheted winch bar 10 may be employed to tighten the cargo strap 2, a drive element, such as an engagement key 90, is disposable within a slot 62 that extends through the mandrel 60 perpendicular to the axis 15. However, the length of the engagement key 90 is greater than the length of the slot 62. Thus, when the engagement key 90 is disposed within the slot 62, the ends of the engagement key 90 extend transversely out of the mandrel 60, so that the engagement key 90 may engage the apertures 7 in the drive member 5 of the cargo winch 1. In order to store the engagement key 90 when the ratcheted winch bar 10 is not being used, a key holder 100 is connected to the ratchet body 14.

The ratchet body 14 selves as a frame upon which the gear 30, pawl 34, and mandrel 60 may be securely attached. As shown in FIG. 4, the ratchet body 14 includes a first ratchet body portion 16 and a second ratchet body portion 18 connected to a ratchet body base 20, which serves to connect the ratchet body 14 to the elongated handle portion 12. The first and second ratchet body portions 16, 18 are substantially similar planar elements that are held in a substantially parallel spaced relationship by fixed connections between each of the first and second ratchet body portions 16, 18 and the ratchet body base 20. Furthermore, the first and second ratchet body portions 16, 18 may be formed integrally with the ratchet body base 20. In order to connect the pawl 34 to the ratchet body 14, a first aperture 22 extends through the first ratchet body portion 16, and a second aperture 24 extends through the second ratchet body portion 18, as will be explained in detail herein. In order to connect the gear 30 and the mandrel 60 to the ratchet body 14, a first hole 26 extends through the first ratchet body portion 16,;and a second hole 28 extends through the second ratchet body portion 18, as will be described in detail herein.

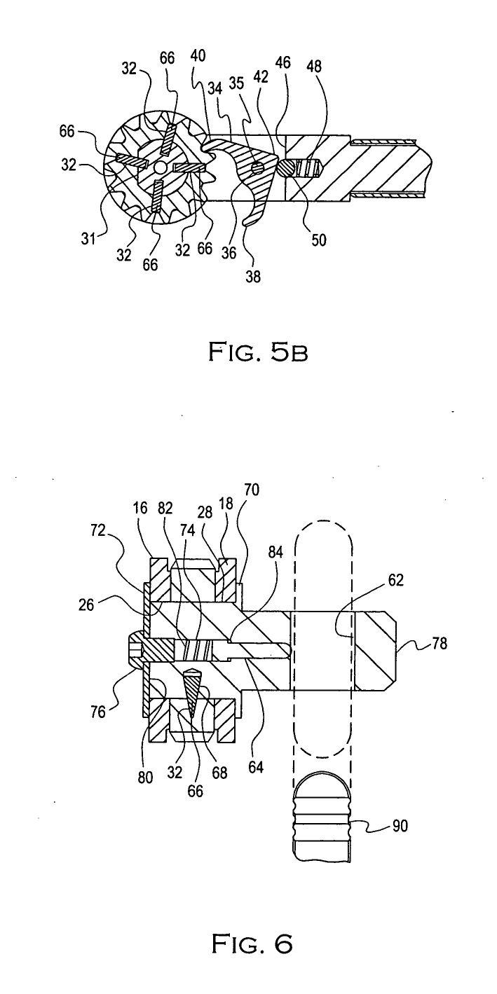

So that the gear 30 may be selectively restrained from moving in either the first direction or the second direction, the pawl 34 is pivotally connected to the ratchet body 14 by a post 35. The post 35 is seated in the first aperture 22 in the first ratchet body portion 16 and the second aperture 24 in the second ratchet body portion 18. The post 35 further extends through a bore 36 in the pawl 34, to thereby retain the pawl 34 between the first ratchet body portion 16 and the second ratchet body portion 18. The pawl 34 may pivot about the post 35 between a first position, wherein a first tooth 38 of the pawl 34 engages the gear 30 as seen in FIG. 5A, and a second position, wherein a second tooth 40 of the pawl 34 engages the gear 30 as seen in FIG. 5B. The pawl 34 is roughly triangular, the first tooth 38, the second tooth 40, and a cornered edge 42 defining corners of the pawl 34. When the pawl 34 is in the first position, the gear 30 is restrained against rotating in the first direction by engagement of the first tooth 38 of the pawl 34 with the gear 30, but the gear 30 is free to rotate in the second direction. When the pawl 34 is in the second position, the gear 30 is restrained against rotating in the second direction by engagement of the second tooth 40 of the pawl 34 with the gear 30, but the gear 30 is free to rotate in the first direction. In order to maintain engagement of the pawl 34 with the gear 30 during rotation of the gear 30, the first tooth 38 of the pawl 34 is biased toward the gear 30 when the pawl 34 is in the first position, and the second tooth 40 of the pawl 34 is biased toward the gear 30 when the pawl 34 is in the second position. In order to bias the first and second teeth 38, 40 of the pawl 34 toward the gear 30 when the pawl 34 is in the first and second positions, respectively, a spring 48 biases a ball 50 into contact with the pawl 34. The spring 48 and ball 50 are disposed within a socket 44 formed in an interior face 46 of the ratchet body base 20. The ball 50 engages the pawl 34 adjacent to the cornered edge 42 of the pawl 34, and the pawl 34 may be moved between the first and second positions by rotating the pawl 34 until the cornered edge 42 moves past the ball 50.

So that the pawl 34 may be selectively moved between the first position and the second position, the second tooth 40 of the pawl 34 extends out of the ratchet body 14 when the pawl 34 is in the first position, as seen in FIG. 5A, and the first tooth 38 of the pawl 34 extends out of the ratchet body 14 when the pawl 34 is in the second position, as seen in FIG. 5B. The user may move the first or second tooth 38, 40, as appropriate, to push the cornered edge 42 past the ball 50, such that the pawl 34 moves between positions.

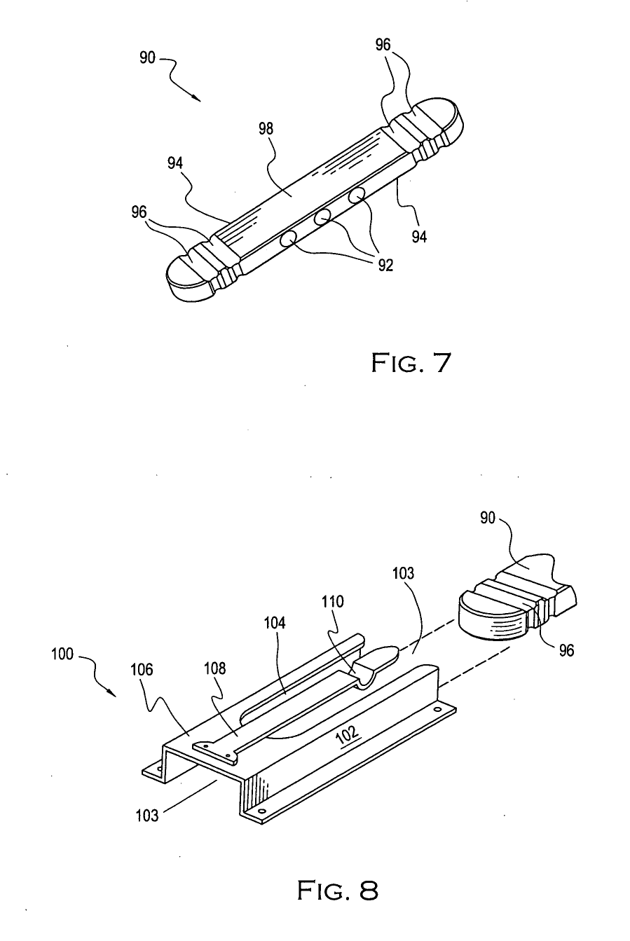

So that the ratcheting action of the gear 30 and pawl 34 may be utilized to control the movement of the mandrel 60, the gear 30 is connected to the mandrel 60 in a fixed rotational relationship. The mandrel 60 extends through a passage 31 formed through the gear 30. A plurality of dowels 66 extend through a plurality of radial apertures 32 in the gear 30 and into corresponding apertures 68 in the mandrel 60, thereby causing the gear 30 and the mandrel 60 to rotate in unison. To retain the gear 30 between the first ratchet body portion 16 and the second ratchet body portion 18, the mandrel extends through the first hole 26 in the first ratchet body portion 16 and the second hole 28 through the second ratchet body portion 18, as shown in FIG. 6. To secure the mandrel 60 with respect to the ratchet body 14, the mandrel 60 includes a flange 70 that engages an exterior surface of the second ratchet body portion 18 adjacent to the second hole 28 through the second ratchet body portion 18. Additionally, a washer 72 connected to the mandrel 60 by a bolt 76 engages an exterior surface of the first ratchet body portion 16 adjacent to the first hole 26 through the first ratchet body portion 16. The bolt 76 secures the washer 72 to the mandrel 60 by threadedly engaging a bore 74 in the mandrel 60, as will be explained in greater detail herein.

The slot 62 extends through the mandrel 60 for securely receiving the engagement key 90 therein. The slot 62 extends substantially perpendicular to the axis 15, thereby creating a radially extending passageway the entire way through the mandrel 60. The slot 62 has a substantially continuous cross sectional shape that is complementary to the cross sectional shape of the engagement key 90. However, the slot 62 intersects the bore 74 near the center of the mandrel 60, as will be explained in greater detail herein.

The bore 74 extends through the mandrel 60 along the axis 15 from a second end 80 of the mandrel 60 toward a first end 78 of the mandrel 60, but terminates at the slot 62. The bore 74 is in communication with the slot 62 such that a retainer element, such as a pin 64, is slidably disposed at least partially within the bore and may extend into the slot 62 to retain the engagement key 90 in the slot 62, as will be described in detail herein. The pin 64 is biased toward the slot 62 by a spring 82 but is restrained from moving completely out of the bore 74 by a shoulder 84 in the bore 74 that engages the pawl 64. The spring 82 is a compression spring that is disposed within the bore 74 of the mandrel 60, compressed between the bolt 76 and the pin 64.

So that the ratcheted winch bar 10 may engage the drive member 5 to thereby tighten the cargo strap 2, the engagement key 90 is extendable through the bore 62 in the mandrel 60, and through a pair of the apertures 7 in the drive member 5 of the cargo winch 1. The engagement key 90 is elongated, such that it is substantially greater in length than the slot 62, such that sufficient portions of the engagement key 90 may extend out of the slot 62 in the mandrel 60 to allow the engagement key 90 to engage the apertures 7 in the drive member 5 of the cargo winch 1 when the mandrel 60 is disposed within the passageway 6 in the drive member 5 of the cargo winch 1. So that the engagement key 90 may be releasably secured within the slot 62, at least one indentation 92 is formed in a side surface 94 of the engagement key 90, as shown in FIG. 7, and the indentation 92 is engageable with the pin 64. The engagement key 90 may be inserted or removed from the slot 62 by exerting sufficient force upon the engagement key 90 to overcome the biasing force acting upon the pin 64 due to the spring 82. So that the engagement key 90 may be stored in the key holder 100 when not in use, the engagement key 90 includes a channel 96 formed in a top surface 98 of the engagement key 90, as will be explained in detail in connection with the description herein of the key holder 100. However, it should be noted that although the channel 96 is described as being in the top surface 98, and the indentation 92 is described as being in the side surface 94, the indentation 92 and channel 96 are not limited to these locations, and it is specifically contemplated that other locations upon the engagement key 90 would also be appropriate.

In order to store and transport the engagement key 90 when the ratcheted winch bar 10 is not in use, an engagement key holder 100 may be attached to the ratchet body 14, on either the first ratchet body portion 16, or the second ratchet body portion 18. As shown in FIG. 8, the key holder 100 includes a substantially rectangular enclosure 102. The substantially rectangular enclosure 102 is open at each end 103, and a partial opening 104 is formed in the top surface 106 of the engagement key holder 100. A spring flange 108 is connected to the top surface 106 of the engagement key holder 100, and overlies the partial opening 104. The spring flange 108 is substantially planar, with the exception of an engaging portion 110 of the spring flange 108, which is a substantially U-shaped bend in the spring flange 108. The engagement key 90 may be disposed within the rectangular enclosure 102 by passing the engagement key 90 through either of the open ends 103 of the substantially rectangular enclosure 103. In order to secure the engagement key 90, the engaging portion 110 of the spring flange 108 engages the channel 96 in the engagement key 90.

In use, a user may employ the ratcheted winch bar 10 of the present invention to tighten the cargo strap 2 of a cargo winch 1. In order to do so the user first removes the engagement key 90 from either the engagement key holder 100, or from the slot 62 in the mandrel 60, if it is so located. Next, the user moves the pawl 34 to the either the first position or the second position, as appropriate, so that the ratcheted winch bar 10 may tighten the cargo strap 2. Once the pawl 34 is properly positioned, the mandrel 60 may be inserted into the drive member 5 of the cargo winch 1.

In order to engage the ratcheted winch bar I with the cargo winch 1, the user first inserts the mandrel 60 into the passageway 6 in the drive member 5, and aligns the slot 62 of the mandrel 60 with the apertures 7 on the drive member 5. Once the apertures 7 have been aligned with the slot 62, the engagement key 90 may be inserted into the slot 62. To do so, the engagement key 90 is first guided through one of the apertures 7, and into the slot 62. The user continues moving the engagement key 90 into the slot 62, overcoming the biasing force of the spring 82 so that the pin 64 retracts into the bore 74, until the indentation 92 in the side surface 94 of the engagement key 90 aligns with the pin 64 such that the pill 64 is biased into engagement with the indentation 92.

Once the pin 64 is engaged with the indentation 92 in the engagement key 90, the engagement key 90 is locked in position with respect to the mandrel 62, and the engagement key 90 extends through both of the apertures 7 in the drive member 5. The user then tightens the cargo strap 2 by first rotating the handle portion 12 of the ratcheted winch bar 10 upward, to a position where the user may develop sufficient leverage to tighten the cargo strap 2 during the downward stroke of the handle 12. It is noted that, when tightening the cargo strap 2, the pawl 34 is positioned such that the mandrel 60 may rotate with respect to the ratchet body 14 during the upward stroke of the handle 12, but during the downward stroke of the handle 12 the pawl 34 locks the mandrel 60 against rotation with respect to the handle 12. Thus, as the user then moves the handle 12 of the ratcheted winch bar 10 downward, the engagement key 90 engages the apertures 7 to thereby rotate the drive member 5 and the drum 4, thereby tightening the cargo strap 2. The user then repeats the steps of ratcheting the handle 12 on the upward stroke and tightening the cargo strap 2 on the downward stroke of the handle 12. When user has finished tightening the cargo strap 2, the user removes the engagement key 90 from the drive member 5 by pulling or pushing the engagement key 90 out of the slot 62 in the mandrel 60. The user then stores the engagement key 90 in the key holder 100 by sliding the engagement key 90 into an open end 103 of the substantially rectangular enclosure 102 until the engaging portion 110 of the spring flange 108 engages the channel 96 in the top surface 98 of the engagement key 90 to thereby secure the engagement key 90 with respect to the key holder 100.

If the user wishes to loosen the cargo strap 2, the user adjusts the pawl 34 accordingly and employs the ratcheted winch bar 10 in similar manner to that described in connection with tightening the cargo strap 2, however, loosening of the cargo strap 2 occurs when the user moves the handle portion 12 of the ratcheted winch bar 10 upward.

While the invention has been described in connection with what is presently considered to be the most practical and preferred embodiment, it is to be understood that the invention is not to be limited to the disclosed embodiments, but to the contrary, it is intended to cover various modifications or equivalent arrangements included within the spirit and scope of the appended claims. The scope is to be accorded the broadest interpretation so as to encompass all such modifications and equivalent structures as is permitted under the law.

What is claimed is:

1. A ratcheted winch bar for winding or tensioning a cargo strap on a cargo winch, comprising:
a handle portion;
a ratchet body connected to an end of said handle portion;
a mandrel rotatably connected to said ratchet body and receivable within said cargo winch; and
an engagement key for engaging said cargo winch to thereby wind said cargo strap, wherein said engagement key is removably attachable to said mandrel.

2. The ratcheted winch bar stated in claim 1, further comprising:
said mandrel extends along an axis which is substantially perpendicular to said handle portion.

3. The ratcheted winch bar stated in claim 2, further comprising:
a slot extending through said mandrel, substantially perpendicular to said axis; and
said engagement key at receivable within said slot.

4. The ratcheted winch bar stated in claim 3, further comprising:
a pin extending at least partially into said slot, and said pin engageable with said engagement key to retain said engagement key within said slot.

5. The ratcheted winch bar stated in claim 3, further comprising:
said engagement key having a greater length than said slot, wherein a first end of said engagement key and a second end of said engagement key extend out of said mandrel when said engagement key is disposed within said slot.

6. The ratcheted winch bar stated in claim 1, further comprising:
an enclosure attached to said ratchet body wherein said engagement key is disposable within said enclosure for transportation and storage.

7. The ratcheted winch bar stated in claim 6, further comprising:
a spring flange attached to said enclosure, and said spring flange engageable with said engagement key to retain said engagement key within said enclosure.

8. The ratcheted winch bar stated in claim 1, further comprising:
a gear disposed within said ratchet body and connected to said mandrel for uniform rotation with said mandrel in a first direction and a second direction; and
a pawl disposed within said ratchet body, said pawl movable between a first position wherein said gear is restrained against rotating in said first direction, and a second position wherein said gear is restrained against moving in said second direction.

9. A ratcheted winch bar for winding or tensioning a cargo strap on a cargo winch, comprising:
an elongated handle portion;
a ratchet body connected to an end of said elongated handle portion;
a gear and associated pawl disposed within said ratchet body;
a mandrel connected to said gear for ratcheted rotation in unison with said gear, and said mandrel receivable within said cargo winch;
a slot extending through said mandrel; and
an engagement key at least partially disposable within said slot for engaging said cargo winch to thereby wind said cargo strap.

10. The ratcheted winch bar stated in claim 9, further comprising:
an axis extending through said ratchet body, perpendicular to said elongated handle portion
said mandrel extends along said axis; and
said slot extends substantially perpendicular to said axis.

11. The ratcheted winch bar stated in claim 9, further comprising:
an indentation formed in a side surface of said engagement key;
a pin extending at least partially into said slot, and said pin engageable with indentation in said engagement key to retain said engagement key within said slot.

12. The ratcheted winch bar stated in claim 9, further comprising:
an enclosure attached to said ratchet body wherein said engagement key is disposable within said enclosure for transportation and storage.

13. The ratcheted winch bar stated in claim 12, further comprising:
a channel formed in the top surface of said engagement key; and
a spring flange attached to said enclosure, and said spring flange engageable with said channel in said engagement key to retain said engagement key within said enclosure.

14. The ratcheted winch bar stated in claim 9, further comprising:
said gear and mandrel uniformly rotatable in a first direction and a second direction; and
said pawl

15. A ratcheted winch bar for rotating a substantially tubular drive member of a cargo winch to thereby tighten a cargo strap, said drive member having a passageway extending therethrough and apertures formed in the annular surface thereof, the ratcheted winch bar comprising:
an elongated handle portion;
a ratchet body connected to an end of said elongated handle portion;
a gear and associated pawl disposed within said ratchet body for uniform rotation with respect to said ratchet body in a first direction and a second direction, and said pawl movable between a first position wherein said gear and said mandrel are restrained against rotating in said first direction, and a second position wherein said gear and said mandrel are restrained against moving in said second direction;
a mandrel receivable within said passageway of said drive member and connected to said gear for rotation in unison with said gear, wherein said mandrel extends along an axis perpendicular to said elongated handle portion;
a slot extending through said mandrel perpendicular to said axis; and
an engagement key at least partially disposable within said slot for engaging said apertures of said drive member to thereby wind said cargo strap.

16. The ratcheted winch bar stated in claim 15, further comprising:
an indentation formed in a side surface of said engagement key;
a pin extending at least partially into said slot, and said pin engageable with indentation in said engagement key to retain said engagement key within said slot.

17. The ratcheted winch bar stated in claim 15, further comprising:
an enclosure attached to said ratchet body wherein said engagement key is disposable within said enclosure for transportation and storage.

18. The ratcheted winch bar stated in claim 17, further comprising:
a channel formed in the top surface of said engagement key; and
a spring flange attached to said enclosure, and said spring flange engageable with said channel in said engagement key to retain said engagement key within said enclosure.
